(19) United States
(12) Patent Application Publication
(10) Pub. No.: US 2004/0261585 A1
(43) Pub. Date: Dec. 30, 2004

(54) Buoyant wrench

(76) Inventor: Bradley Birns, Cooper City, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/603,969

(22) Filed: Jun. 25, 2003

(51) Int. Cl. B25B 13/00

(52) U.S. Cl. 81/125.1

(57) ABSTRACT

A buoyant wrench is disclosed including a first engagement end having a first engagement region, a body positioned adjacent to the first engagement end, the body incorporating an indicator, and a second engagement end having a second engagement region, the second engagement end positioned adjacent to the body and opposite the first engagement end.

### TECHNICAL FIELD

The present invention relates generally to tools. More particularly, the present invention is directed towards a buoyant tool that includes an indicator for locating the buoyant tool floating on the surface of water.

### BACKGROUND OF THE INVENTION

Carpenters, electricians, fishermen, mechanics and homeowners commonly use hand held tools such as pliers, screwdrivers, and wrenches. Unfortunately, these types of tools are generally constructed of a metal material such as steel and may or may not include some form of insulated handle or covering made of a non-conductive material such as plastic or rubber. Thus, when used around any type of electrical source, the tools are capable of conducting electricity and causing severe electrical shock or electrocution.

Furthermore, for fishermen, offshore oil workers and others working or enjoying recreational activities around water, these expensive tools are frequently inadvertently dropped into water, quickly sinking and rarely retrieved. Additionally, metal tools often rust or corrode when used near water or in locations of high humidity. Although plastic hand held fishing pliers, such as those found in U.S. Pat. No. 4,185,523 have been previously developed, these pliers lack the durability and strength required to be used in various common applications. Furthermore, the plastic pliers float only as a result of a burdensome styrofoam material positioned between the handle portions of the pliers.

A buoyant tool, such as a wrench, must have a specific gravity less than or equal to 1.0 in order to enable floatation, yet be strong enough to apply the requisite torque to satisfy torque specifications. The goals of floatation and strength are at cross-purposes. Increasing the floatability of the device requires lighter weight material of reduced torque capability. Increasing the strength of the device for higher torque rating requires a heavier grade member, which will sink if its specific gravity is greater than 1.0

A common problem encountered by most persons who use a buoyant tool is the locating of the tool after it is dropped into the water. It is often extremely difficult to locate the floating tool in choppy water, or even in the glare of the sun. Thus a need exists for a buoyant tool having requisite torque applying abilities and an indicator, such as a reflector or light, so that the user can locate the buoyant tool after it has been dropped into the water.

### SUMMARY OF THE INVENTION

The present invention eliminates the above-mentioned needs for a buoyant tool by providing buoyant tool incorporating an indicator so that a user can locate the buoyant tool after it has been dropped into the water.

In accordance with the present invention, there is provided a buoyant wrench including a first engagement end having a first engagement region, a body positioned adjacent to the first engagement end, the body incorporating an indicator, and a second engagement end having a second engagement region, the second engagement end positioned adjacent to the body and opposite the first engagement end.

The present invention is additionally directed to a buoyant wrench including an engagement end having an engagement region, and a body positioned adjacent to the first engagement end, the body incorporating an indicator.

The present invention is further directed to a method for forming a buoyant wrench, the method including the steps of positioning an engagement end having an engagement region adjacent to a body, and incorporating an indicator in the body.

### BRIEF DESCRIPTION OF THE DRAWINGS

FIG. 1 is a side view illustration of the preferred embodiment of the present invention.

FIG. 2 is a side view illustration of an alternative embodiment of the present invention of FIG. 1.

FIG. 3 is a side view illustration of an alternative embodiment of the present invention of FIG. 1.

### DETAILED DESCRIPTION OF THE DRAWINGS

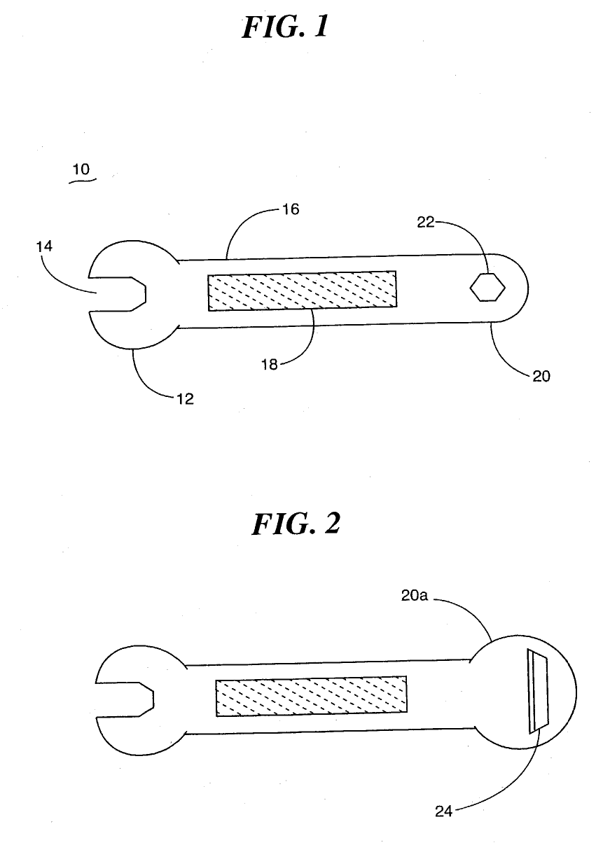

Referring now to FIG. 1, a preferred embodiment of the present invention is illustrated as buoyant wrench 10. Buoyant wrench 10 includes a first engagement end 12 having a first engagement region 14, a body 16 having indicator 18, and a second engagement end 20 having a second engagement region 22.

First engagement end 12 is illustrated as a wrench head, however it is contemplated that first engagement end 12 may be selected from a variety of tool types, including but not limited to screwdrivers, hex wrenches, hammers, and clamps. First engagement end 12 includes first engagement region 14. First engagement region 14 is provided to accommodate an element of a structure, such as a hex nut, so that buoyant wrench 10 can manipulate the element in a manner desired by the user.

Should the user drop buoyant wrench 10 into water during an aforementioned act of manipulation, the buoyant qualities of buoyant wrench 10 allow the user to retrieve buoyant wrench 10. Buoyant wrench is preferably of unitary construction and formed from a material having a specific gravity of 1.0 or less. Such materials can include but are not limited to plastics and rigid polymers.

Additionally, body 16 is positioned adjacent to first engagement end 12 and second engagement end 20 and includes at least one indicator 18 to assist the user in locating buoyant wrench. Indicator 18 can be formed from any one of a number of materials, including but not limited to reflective material, luminescent material, colored material, and/or combinations thereof.

In practice, when buoyant wrench 10 is dropped into water, the user will begin to attempt to locate it. If indicator 18 is constructed from reflective or colored material, light striking the reflective or colored indicator will be reflected off of indicator 18, thereby permitting the user to more easily identify the location of buoyant wrench 10. Alternatively, if indicator 18 is formed from a luminescent material, the light given off by the luminescent indicator will permit the user to more easily identify the location of buoyant wrench 10 during low-light conditions.

Additionally, as illustrated in FIGS. 1-3, a second engagement end 20 having a second engagement region 22 may be provided. Second engagement end 20 is illustrated as a hex wrench head, however it is contemplated that second engagement end 20 may be selected from a variety of tool types, including but not limited to screwdrivers, wrenches, hammers, and clamps. Second engagement end 20 includes second engagement region 22. Second engagement region 22 is provided to accommodate an element of a structure, such as a hex nut, so that buoyant wrench 10 can manipulate the element in a manner desired by the user.

Alternatively, as illustrated in FIG. 2 second engagement end 20a can be constructed to open bottles, incorporating bottle opener 24.

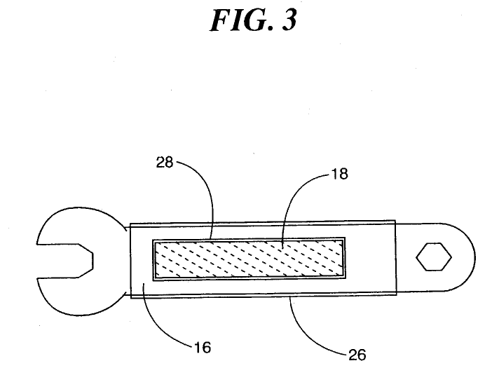

Referring now to FIG. 3, buoyant wrench 10 can further include a slip-resistant member 26. Slip-resistant member 26 is provided on body 16 so as to improve grip for the user. A cutaway region 28 in slip-resistant member 26 allows visibility of indicator 18 to remain unobstructed to the user. Slip-resistant member 26 can be constructed of various materials, including but not limited to rubber, plastic, and other slip-resistant polymers.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

1. A buoyant wrench, comprising:
a first engagement end having a first engagement region;
a body positioned adjacent to said first engagement end, said body incorporating a reflective material; and
a second engagement end having a second engagement region, said second engagement end positioned adjacent to said body and opposite said first engagement end.

2. The buoyant wrench according to claim 1 wherein said buoyant wrench has a specific gravity of less than 1.0.

3. The buoyant wrench according to claim 1 wherein said reflective material is positioned on said body to reflect light from a light source.

4. (Cancelled).

5. The buoyant wrench according to claim 1 wherein said reflective material includes a luminescent material.

6. A buoyant wrench, comprising:
an engagement end having an engagement region; and
a body positioned adjacent to said engagement end, said body incorporating a reflective material.

7. The buoyant wrench according to claim 6 wherein said buoyant wrench has a specific gravity of less than 1.0.

8. The buoyant wrench according to claim 6 wherein said reflective material is positioned on said body to reflect light from a light source.

9. (Cancelled).

10. The buoyant wrench according to claim 6 wherein said reflective material includes a luminescent material.

11. A method for forming a buoyant wrench, said method including the steps of:
positioning an engagement end having an engagement region adjacent to a body; and
incorporating a reflective material in said body.
